(19) United States
(12) Patent Application Publication
(10) Pub. No.: US 2009/0282434 A1
(43) Pub. Date: Nov. 12, 2009

(54) Digital broadcast receiver

(76) Inventors: Tsuneki YASUHO, Osaka (JP); Hiroshi AOKI, Hiroshima (JP); Yasunobu KANZAKI, Hyogo (JP); Keisuke IWATA, Osaka (JP); Tsuyoshi IDE, Osaka (JP); Tatsuto HORIBE, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/186,755

(22) Filed: Aug. 6, 2008

(30) Foreign Application Priority Data
Aug. 6, 2007 (JP) 2007-204404

(51) Int. Cl. H04N 7/025

(52) U.S. Cl. 725/33

(57) ABSTRACT

There is provided a digital broadcast receiver for solving various problems regarding a display which arise due to the switching of a mode. For example, there is provided a digital broadcast receiver capable of displaying an emergency alert broadcast by an EAS even when a mode is switched from an OCAP mode to an external input mode. The receiver has a plane management unit for managing a receiver only plane and a download application plane. The receiver prohibits the emergency alert broadcast from being displayed in the receiver only plane when, under an OCAP mode, a download application takes away an EAS function of the receiver, and then permits the emergency alert broadcast to be displayed in the receiver only plane when the mode is switched from the OCAP mode to an external input mode.

### BACKGROUND OF THE INVENTION

1. Field of the Invention

The present invention relates to a receiver of a digital broadcast such as a cable broadcast.

2. Related Art

Recently, digitalization has been progressed in a cable broadcast, and various kinds of services are provided. Various kinds of techniques for a receiver of the cable broadcast have been developed (refer to JP-A-2006-511106, for example). The OCAP (Open Cable Application Platform) has been proposed as a next-generation cable broadcast standard in North America.

According to the OCAP, a receiver such as a STB (Set Top Box) can download various kinds of applications (Java application) such as an electronic program guide (EPG) and an application for watching a VOD (Video on Demand) from a station, and implements a predetermined function by executing the downloaded application based on the API (Application Program Interface) defined by the OCAP standard. Such a receiver checks whether a download application and the like to be transmitted from the station periodically is delivered or not when a power supply is turned on, and executes the download application when it is delivered.

The receiver holds an application installed originally (referred to as the “embedded application” hereinafter) as well as the download application transmitted from the station.

The receiver has pixel data for one screen called a plane for each of the embedded application and the download application. When the receiver executes the download application, it superimposes an embedded application plane on a download application plane and displays it on a display (referred to as the “OCAP mode” hereinafter).

In addition, the receiver can be connected to an external device such as a DVD reproduction device in general. A video outputted from the external device to the receiver is displayed on the display by superimposing the embedded application plane on an external input plane (referred to as the “external input mode” hereinafter).

The receiver selects either the video from the received download application or the video from the external device, and displays the selected video on the display.

Furthermore, the receiver can be connected to an external device such as a DVD recorder in general. The download application plane is outputted from the receiver to the external device (referred to as the “external output mode” hereinafter).

Thus, since the receiver switches the plane to be used based on the OCAP mode, the external input mode and the external output mode, various problems regarding the display arise due to the switching of the mode.

For example, when the mode is switched from the OCAP mode to the external input mode, the problem is that an emergency alert broadcast by an EAS (Emergency Alert System) is not displayed on the display. Such the problem will be described in detail hereinafter.

Conventionally, the EAS for displaying character information of the emergency alert broadcast in a part or a whole of the display in the event of a natural disaster is used in the United States. The embedded application has a function for displaying the emergency alert broadcast by the EAS, and in the emergency alert broadcast by the EAS before the OCAP is proposed, the embedded application plane is used and displayed. Meanwhile, the download application also has a display function of the emergency alert broadcast by the EAS. When the download application displays the emergency alert broadcast, it deprives the embedded application of the display function of the EAS using the OCAP-compliant API and displays the emergency alert broadcast of the EAS by using the download application plane.

However, the problem is that since the download application plane is not displayed under the external input mode, when the mode is switched from the OCAP mode to the external input mode after the download application deprives the embedded application of the EAS function under the OCAP mode, the emergency alert broadcast cannot be displayed on the display.

### SUMMARY OF THE INVENTION

The present invention has been made to solve the above problem and it is an object of the present invention to provide a digital broadcast receiver capable of solving the various kinds of problems regarding a display due to a switching of a mode. For example, it is an object of the present invention to provide a digital broadcast receiver capable of displaying an emergency alert broadcast by an EAS even when a mode is switched from an OCAP mode to an external input mode after a download application deprives an embedded application of the display function of the EAS under the OCAP mode.

According to a first aspect of the present invention, a digital broadcast receiver implements functions by using an embedded application and a download application acquired through a network. The embedded application has a function of displaying an emergency alert broadcast, and the download application is capable of taking away the function of displaying the emergency alert broadcast. The digital broadcast receiver includes: a plane management unit that manages a download application plane capable of displaying the emergency alert broadcast by the download application, a receiver only plane capable of displaying the emergency alert broadcast by the embedded application, and an external input plane capable of displaying information inputted from an external device; a synthesis unit that generates first screen data by synthesizing the download application plane and the receiver only plane, and generates second screen data by synthesizing the external input plane and the receiver only plane; a display that displays the first screen data under a first mode in which the download application is executed, and displays the second screen data under a second mode in which information inputted from the external device is displayed; and a control unit that controls whether or not to display the emergency alert broadcast in the receiver only plane, and prohibits the emergency alert broadcast from being displayed in the receiver only plane when, under the first mode, the download application takes away the function of displaying the emergency alert broadcast, wherein the control unit permits the emergency alert broadcast to be displayed in the receiver only plane when a mode is switched from the first mode to the second mode.

In case that the emergency alert broadcast is a broadcast to deliver character information and to control displaying of video information by controlling displaying of the first screen data on the display and a forced channel selection, and the download application plane includes an OSD plane for displaying the character information, and a video plane for displaying the video information, the control unit may control so that the OSD plane is prevented from being outputted from the plane management unit to the synthesis unit when the emergency alert broadcast is delivered and the first screen data is forcedly displayed on the display after the mode is switched from the first mode to the second mode under the condition that the download application takes away the function of displaying the emergency alert broadcast.

In case that the emergency alert broadcast is a broadcast to deliver character information and to control displaying of video information by controlling displaying of the first screen data on the display and a forced channel selection, the control unit may prohibit the emergency alert broadcast from being displayed in the receiver only plane when the emergency alert broadcast is delivered and the first screen data is forcedly displayed on the display after the mode is switched from the first mode to the second mode under the condition that the download application takes away the function of displaying the emergency alert broadcast.

The digital broadcast receiver may further include a timer that sets a time period during which the emergency alert broadcast is displayed. In this case, the control unit may complete the display of the emergency alert broadcast under the second mode when a time since start of the display of the emergency alert broadcast under the first mode reaches the time set in the timer, in the case where the mode is switched from the first mode to the second mode before a time since the start of the display of the emergency alert broadcast under the first mode reaches the time set in the timer under the condition that the download application takes away the function of displaying the emergency alert broadcast.

According to a second aspect of the present invention, a digital broadcast receiver has a first mode in which screen data displayed by executing a download application acquired through a network is outputted to the outside, a second mode in which the download application is executed to display screen data, and a third mode in which information inputted from an external device is displayed. The digital broadcast receiver includes: a plane management unit that manages an emergency alert broadcast plane for displaying an emergency alert broadcast, a download application plane used when the download application is executed, a receiver only plane, and an external input plane for displaying information inputted from an external device; a synthesis unit that generates first screen data by synthesizing the emergency alert broadcast plane and the download application plane, generates second screen data by synthesizing the first screen data and the receiver only plane, and generates third screen data by synthesizing the emergency alert broadcast plane, the external input plane and the receiver only plane; and a display, wherein the first screen data is outputted to the outside under the first mode, the second screen data is outputted to the display under the second mode, and the third screen data is outputted to the display under the third mode.

According to a third aspect of the present invention, a digital broadcast receiver has a first mode in which screen data displayed by executing a download application acquired through a network is outputted to the outside, a second mode in which the download application is executed to display screen data, and a third mode in which information inputted from an external device is displayed. The digital broadcast receiver includes: a plane management unit that manages a personal identification number plane for displaying a personal identification number input screen, a download application plane used when the download application is executed, a receiver only plane, and an external input plane for displaying information inputted from an external device; a synthesis unit that generates first screen data by synthesizing the personal identification number plane, the download application plane, and the receiver only plane, and generates second screen data by synthesizing the external input plane and the receiver only plane; and a display, wherein the download application plane is outputted to the outside under the first mode, the first screen data is outputted to the display under the second mode, and the second screen data is outputted to the display under the third mode.

According to the present invention, the various problems regarding the display due to the switching of the mode can be solved. For example, according to the first aspect of the present invention, the emergency alert broadcast by the EAS can be displayed by permitting the display of the EAS in the receiver only plane even when the mode is switched from the OCAP mode to the external input mode after the download application deprives the embedded application of the display function of the EAS under the OCAP mode. According to the second aspect of the present invention, since the emergency alert broadcast plane is provided, as well as being capable of displaying the emergency alert broadcast by the EAS in the case where the mode is switched from the OCAP mode to the external input mode after the download application deprives the embedded application of the display function of the EAS under the OCAP mode, the emergency alert broadcast by the EAS broadcasted at the time of recording can be prevented from being displayed when a video recorded under the external output mode is reproduced under the external input mode. According to the third aspect of the present invention, since the personal identification number plane for inputting the personal identification number is provided, when the video recorded under the external output mode is reproduced under the external input mode, the personal identification number input screen for canceling the parental control is prevented from being displayed and thus the video can be seen.

### BRIEF DESCRIPTION OF THE DRAWINGS

FIG. 1 is a diagram showing hardware configuration of a receiver for receiving a cable broadcast according to a first embodiment and a second embodiment of the present invention;

FIG. 2 is a diagram showing a functional configuration of the receiver according to the first embodiment and the second embodiment;

FIG. 3 is a diagram showing internal configurations of a plane management unit and a synthesis unit according to the first embodiment;

FIGS. 4A, 4B and 4C are views showing plane hierarchies according to the first embodiment, in which FIG. 4A shows a plane hierarchy under an OCAP mode, FIG. 4B shows a plane hierarchy under an external input mode, and FIG. 4C shows a plane hierarchy under an external output mode;

FIG. 5 is a flowchart showing display control of the EAS when a mode is switched from the OCAP mode to the external input mode according to the first embodiment;

FIG. 6 is a view showing transition of the plane hierarchies when a channel is forcedly selected according to the first embodiment, in which (a) shows the plane hierarchy under the OCAP mode, (b) shows the plane hierarchy under the external input mode, and (c) shows a plane hierarchy after the channel is forcedly selected;

FIG. 7 is a diagram showing a configuration of a receiver corresponding to FIG. 6;

FIG. 8 is a flowchart showing screen control corresponding to FIG. 6;

FIG. 9 is a diagram showing a display time of the EAS when the mode is switched from the OCAP mode to the external input mode while the EAS is displayed according to the first embodiment;

FIG. 10 is a diagram showing a configuration of a receiver to control the EAS display time when the mode is switched from the OCAP mode to the external input mode while the EAS is displayed;

FIG. 11 is a flowchart showing the display control of the EAS corresponding to FIG. 10;

FIG. 12 is a diagram showing a configuration in which an EAS only plane is added in a plane management unit according to the second embodiment;

FIGS. 13A, 13B and 13C are views showing plane hierarchies corresponding to FIG. 12, in which FIG. 13A shows a plane hierarchy under the OCAP mode, FIG. 13B shows a plane hierarchy under the external input mode, and FIG. 13C shows a plane hierarchy under the external output mode;

FIG. 14 is a view showing a configuration in which a PID only plane is further added in the plane management unit according to the second embodiment; and

FIGS. 15A, 15B, and 15C are views showing plane hierarchies corresponding to FIG. 14, in which FIG. 15A shows a plane hierarchy under the OCAP mode, FIG. 15B shows a plane hierarchy under the external input mode, and FIG. 15C shows a plane hierarchy under the external output mode.

### DETAILED DESCRIPTION OF THE PREFERRED EMBODIMENTS

Embodiments of the present invention will be described with reference to the accompanying drawings hereinafter.

### First Embodiment

### 1.1 Hardware Configuration of Receiver

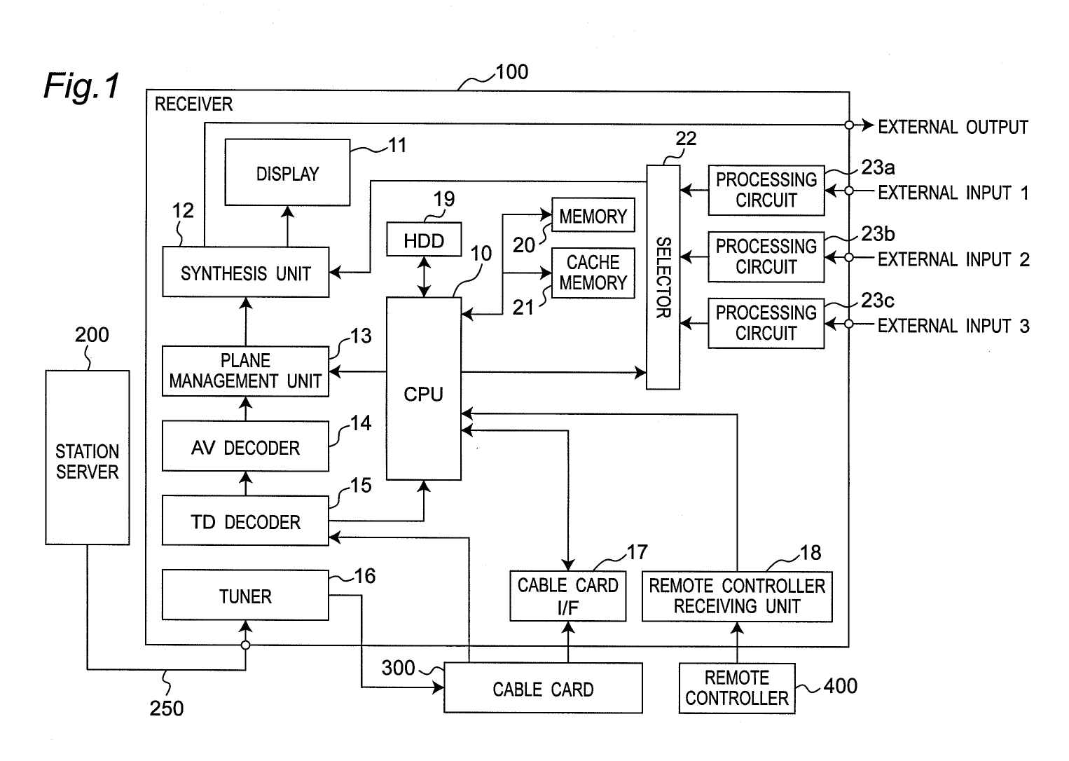

FIG. 1 is a diagram showing a hardware configuration of a receiver for receiving a cable broadcast according to one embodiment of the present invention. A receiver 100 according to this embodiment can receive an OCAP (Open Cable Application Platform)-standard-compliant cable broadcast (refer to “OpenCable™ Application Platform Specifications, OCAP1.0 Profile, OC-SP-OCAP1.0.1-070824”. These contents are incorporated herein by reference). Note that a configuration for processing an audio signal is omitted in FIG. 1 for simplification.

A cable card 300 for receiving the cable broadcast is inserted into the receiver 100. The cable card 300 is a card by which the broadcast can be received from a specific cable broadcast station. The receiver 100 has a cable card interface 17 for exchanging data with the cable card 300.

The receiver 100 has a remote controller receiving unit 18 for receiving a signal from a remote controller 400. The receiver 100 receives user operation information (key code) through the remote controller 400 and performs an operation based on the above operation.

The receiver 100 is connected to a station server 200 through a cable 250. The server 200 is set in the cable broadcast station and provides the cable broadcast.

The receiver 100 has a tuner 16, a TD decoder 15 and an AV decoder 14 for reproducing the cable broadcast. The tuner 16 receives a signal transmitted from the cable broadcast station through the cable 250. The TD decoder 15 demultiplexes a transport stream in which audio, video and data are multiplexed to separate it into audio, video and data. The AV decoder 14 decodes audio/video data in MPEG or other format transmitted from the cable station.

The receiver 100 has an input system (external input 1, external input 2, and external input 3) for inputting video audio information from a plurality of external devices other than the information from the cable broadcast. The external inputs are connected to processing circuits 23a to 23c for processing a video audio signal, respectively and one of the outputs of the processing circuits 23a to 23c is selected by a selector 22.

A CPU 10 is a controller to control the operation of the receiver 100. The CPU 10 is connected to a hard disk drive (HDD) 19 as storing means of data, a volatile memory 20 and a cache memory 21 as nonvolatile storing means.

A plane management unit 13 holds a plane displayed on a display 11. The plane includes a plane for an embedded application, a plane for an OCAP application, and a plane for an external input. A synthesis unit 12 synthesizes these planes. The synthesized plane is displayed on the display 11, or outputted from an external output to the external device such as a recorder.

The display 11 processes a video outputted from the synthesis unit 12, such as a video reproduced by an application installed before shipment (referred to as the “embedded application” hereinafter) or an application acquired from the server 200 of the cable broadcast station by downloading (referred to as the “OCAP application” hereinafter), or a video of the external input selected by the selector 22 and displays the processed video. In addition, according to the receiver 100 in this embodiment, any one of the cable broadcast and the external inputs 1 to 3 is selected by using the CPU 10 based on the user operation and outputted on the display 11.

### 1.2 Functional Configuration of Receiver

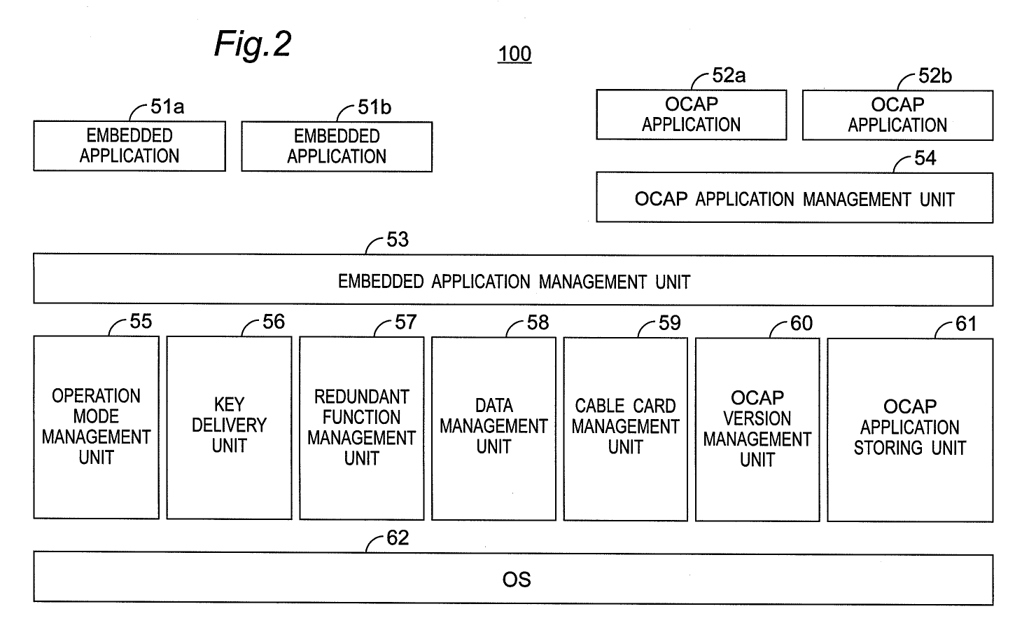

FIG. 2 shows a functional configuration of the receiver 100. The functional configuration shown in FIG. 2 is implemented when the CPU 10 executes a predetermined program. Note that only main functions are shown in FIG. 2 for the sake of simplification of the description. It is needless to say that after-mentioned functions of the receiver 100 can be implemented when the CPU 10 executes a certain program even if the functions are not shown in FIG. 2.

As shown in FIG. 2, the receiver 100 includes embedded applications 51a and 51b, OCAP applications 52a and 52b. Each of the embedded applications 51a and 51b and the OCAP applications 52a and 52b includes a channel selection application, an EAS (Emergency Alert System) display application, a banner display application, a parental control display application, a setting application and the like.

An OCAP application management unit 54 is a middleware for executing the OCAP applications 52a and 52b, and controls activation of the OCAP applications 52a and 52b and delivery of keys to the OCAP applications 52a and 52b. An embedded application management unit 53 controls screen exclusion of the embedded application and key delivery to the embedded application, and controls activation of the OCAP application management unit 54. In the key delivery control, when there is a common key between the OCAP application and the embedded application, the key may be delivered to both of them or delivered to the embedded application only. For example, an up/down key during displaying menu of the receiver 100 is transmitted only to the embedded application of the receiver 100. That is, in some cases, when a screen by the embedded application is displayed on the front of a screen by the OCAP application, the key may be transmitted only to the embedded application.

An operation mode management unit 55 is a module for managing an operation mode of the receiver 100. The operation mode includes an operation mode for executing the OCAP application (referred to as the “OCAP mode” hereinafter), and an operation mode for executing the embedded application (referred to as the “IDTV mode (or non-OCAP mode)” hereinafter). An external input mode for displaying and reproducing the video audio information from the external device is contained in the non-OCAP mode. The operation mode management unit 55 manages the states of the embedded applications 51a and 51b, and the states of the OCAP applications 52a and 52b acquired from the OCAP application management unit 54, and informs an redundant function management unit 57 of each state when the above states change.

A key delivery unit 56 is a module for delivering a key code from the remote controller 400 to the embedded application management unit 53. For example, when the key code is only for the embedded applications 51a and 51b, the key delivery unit 56 delivers the key code only to the embedded applications 51a and 51b, and when the key code is only for the OCAP applications 52a and 52b, the key delivery unit 56 delivers the key code only to the OCAP applications 52a and 52b through the OCAP application management unit 54. In addition, when the key code is common to the embedded applications 51a and Sib and the OCAP applications 52a and 52b, the key delivery unit 56 delivers the key code to both of the embedded applications 51a and 51b and the OCAP applications 52a and 52b.

The redundant function management unit 57 determines exclusion/share between the embedded applications 51a and 51b and the OCAP applications 52a and 52b. Furthermore, the redundant function management unit 57 holds exclusion/share information.

A data management unit 58 manages initial data and updated data by the embedded applications 51a and 51b or the OCAP applications 52a and 52b. For example, the data management unit 58 manages PIN (Personal Identification Number) information, parental information and the like.

A cable card management unit 59 is a module for receiving, managing and executing a request from the cable card 300.

An OCAP version management unit 60 manages versions of the OCAP applications 52a and 52b held in an OCAP application storing unit 61, and upgrades the OCAP applications 52a and 52b based on a received XAIT (Extended Application Information Table). Here, the XAIT is management information of the OCAP applications 52a and 52b transmitted from the station server 200, and includes, at least, version information and storage locations of the OCAP applications 52a and 52b (for example, URL information of the server 200), as information of the OCAP applications 52a and 52b to be started. The OCAP application storing unit 61 holds the downloaded OCAP applications 52a and 52b.

An OS (Operating System) 62 is software for managing the whole receiver 100.

### 1.3 Display Control of EAS

A description will be made of display control of emergency alert broadcast by an EAS when the mode is switched from the OCAP mode to the external input mode in the receiver 100 having the above configuration according to this embodiment. In the United States, an EAS signal is transmitted as an emergency broadcast through a transmission path called an OOB (Out of Band) (refer to SCTE18 standard). The switching to the external input mode is performed when the key code for input switching is delivered from the remote controller 400 to the embedded applications 51a and 51b through the key delivery unit 56.

### 1.3.1 Display Control of EAS in External Input Mode

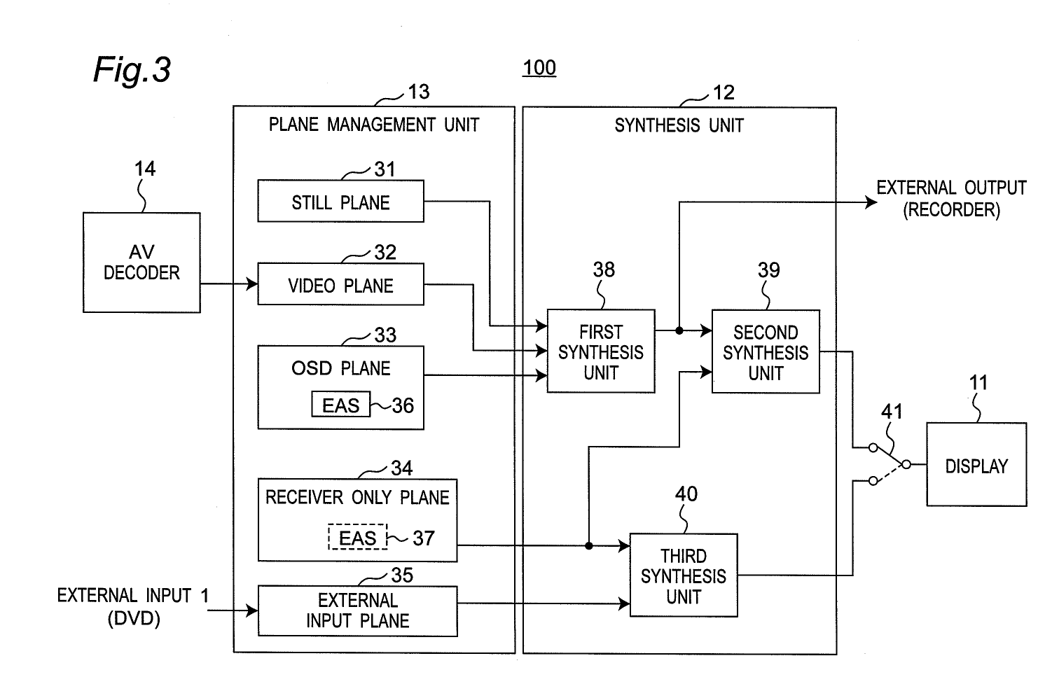

FIG. 3 shows internal configurations of the plane management unit 13 and the synthesis unit 12. The plane management unit 13 has a plurality of planes 31 to 35. Each plane is pixel data for one screen stored in a memory region.

The Still plane 31, and the video plane 32 and the OSD (On Screen Display) plane 33 are planes for the OCAP application. The Still plane 31 contains a background image, and the video plane 32 contains an audio/video data of the cable broadcast decoded by the AV decoder 14, and the OSD plane 33 contains OSD information such as a character and a button (for example, a pixel map for displaying characters such as “getting OCAP”). The receiver only plane 34 is a plane for the embedded application only. The external input plane 35 is a plane for displaying video information from one external input selected by the selector 22. FIG. 3 shows the case where the input from the external input 1 is selected by the selector 22.

The synthesis unit 12 has a first synthesis unit 38 for synthesizing the planes 31, 32 and 33 for the OCAP application, a second synthesis unit 39 for synthesizing the output of the first synthesis unit 38 and the receiver only plane 34, and a third synthesis unit 40 for synthesizing the receiver only plane 34 and the external input plane 35.

Screen data of the OCAP application as an output of the second synthesis unit 39 and screen data of the external input as an output of the third synthesis unit 40 are switched by a switch 41, and either screen data is inputted and displayed on the display 11. In the case of the external output, the screen data of the first synthesis unit 38 is outputted to the recorder.

The embedded applications 51a and 51b have a display function of the emergency alert broadcast by the EAS (referred to as the “EAS function”). When the embedded applications 51a and 51b display the emergency alert broadcast, the receiver only plane 34 is used. In addition, when the OCAP applications 52a and 52b deprive the embedded applications 51a and 51b of the EAS function using an API compliant with the OCAP standard, they can also display the emergency alert broadcast. When the OCAP applications 52a and 52b display the emergency alert broadcast, the OSD plane 33 is used. The characters of the emergency alert broadcast are displayed on a part or a whole of the plane. Hereinafter, the emergency alert broadcast displayed in the OSD plane 33 is referred to as an EAS 36, and the emergency alert broadcast displayed in the receiver only plane 34 is referred to as an EAS 37.

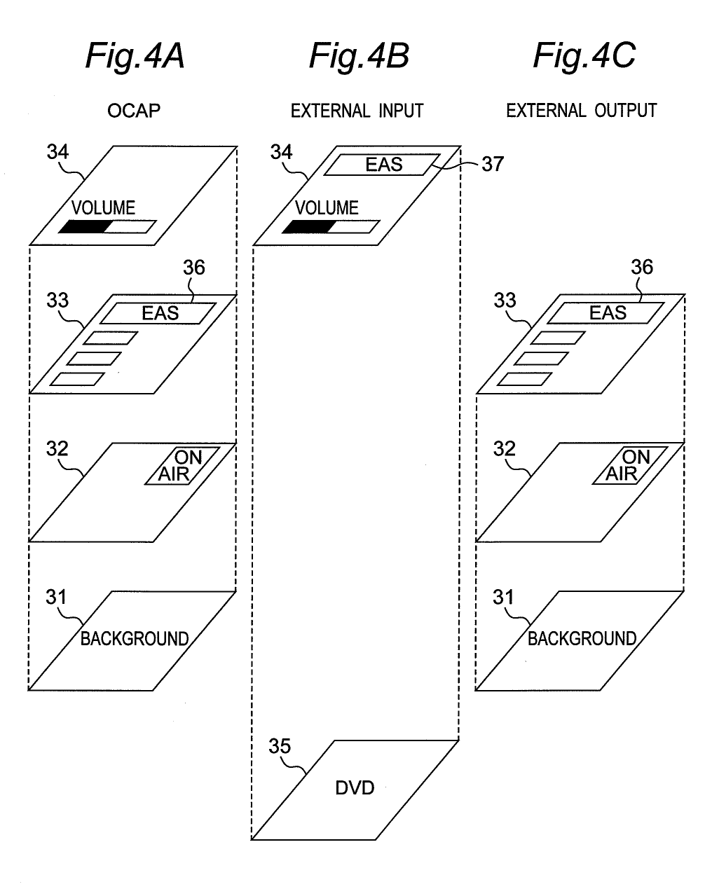

The screen data outputted from the synthesis unit 12 is shown in FIGS. 4A to 4C.

FIG. 4A shows a hierarchy of the plane under the OCAP mode, that is, when the screen data is outputted from the second synthesis unit 39 to the display 11. In this case, the Still plane 31, the video plane 32, the OSD plane 36 and the receiver only plane 34 are overlapped in this order from the bottom and displayed on the display 11.

FIG. 4B shows a hierarchy of the plane under the external input mode, that is, when the screen data is outputted from the third synthesis unit 40 to the display 11. In this case, the external input plane 35 and the receiver only plane 34 are overlapped in this order from the bottom and displayed on the display 11.

FIG. 4C shows a hierarchy of the plane when a screen by the OCAP application is outputted to the recorder, that is, when the screen data is outputted from the first synthesis unit 38 to the external output. In this case, the Still plane 31, the video plane 32, and the OSD plane 36 are overlapped in this order from the bottom and outputted.

When the OCAP application takes away the EAS function of the receiver 100 using the API compliant with to the OCAP standard, since the EAS 36 is displayed in the OSD plane 33, the receiver 100 controls so that the EAS 37 is prevented from being displayed in the receiver only plane 34 (FIG. 4A). However, since the OSD plane 33 is not displayed on the display 11 under the external input mode, when the mode is switched to the external input mode after the EAS function is taken away by the OCAP application, a user cannot see the EAS 36 (FIG. 4B). Thus, according to this embodiment, the EAS 37 is controlled so as to be displayed in the receiver only plane 34 under the external input mode.

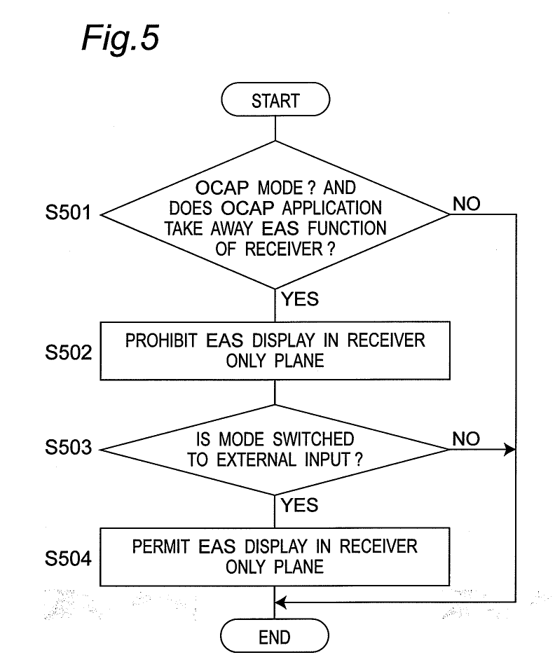

FIG. 5 shows the flow of the above control. The control shown in FIG. 5 is executed by the function shown in FIG. 2 which is realized when the CPU 10 executes a predetermined program. The operation mode management unit 55 determines whether or not, under the OCAP mode, the OCAP application has taken away the EAS function of the receiver 100 using the API compliant with the OCAP standard (S501). In the case of YES in S501, the embedded application management unit 53 sets the display of the EAS 37 in the receiver only plane 34 to “prohibition” (S502). When the mode is the OCAP mode, the switch 41 shown in FIG. 3 is connected to the second synthesis unit 39.

The key delivery unit 56 determines whether the key code for switching the display of the display 11 to the external input has been received or not (S503). When the key code for switching the display of the display 11 to the external input is received, the switch 41 is switched so as to be connected to the third synthesis unit 40. In addition, when the display of the display 11 is switched to the external input, the embedded application management unit 53 sets the display of the EAS 37 in the receiver only plane 34 to “permission” (S504).

Thus, when the mode is switched from the OCAP mode to the external input mode, the display of the EAS 37 set to “prohibition” is set to “permission”. As a result, even when the mode is switched from the OCAP mode to the external input mode after the download application deprives the embedded application of the function of the EAS under the OCAP mode, in the case where the emergency alert broadcast is generated, the EAS 37 can be displayed in the receiver only plane 34. Thus, the user can see the EAS even when the external input is selected.

1.3.2 Screen Control when EAS Forced Channel Selection is Generated after the Mode is Switched from OCAP Mode to External Input Mode

The OCAP standard includes a rule that a channel is forcedly selected so as to display an emergency alert broadcast program as well as the characters informing the emergency alert are displayed on the screen when the emergency alert broadcast is generated. Meanwhile, since the receiver 100 sets the display of the EAS 37 in the receiver only plane 34 to “permission” when the mode is switched to the external input as described above, in the case where the switch 41 is connected to the second synthesis unit 39 when the channel is forcedly selected, the EAS is displayed in each of the OSD plane 33 and receiver only plane 34. Thus, according to this embodiment, when the channel is forcedly selected, the EAS is to be displayed only in one of them.

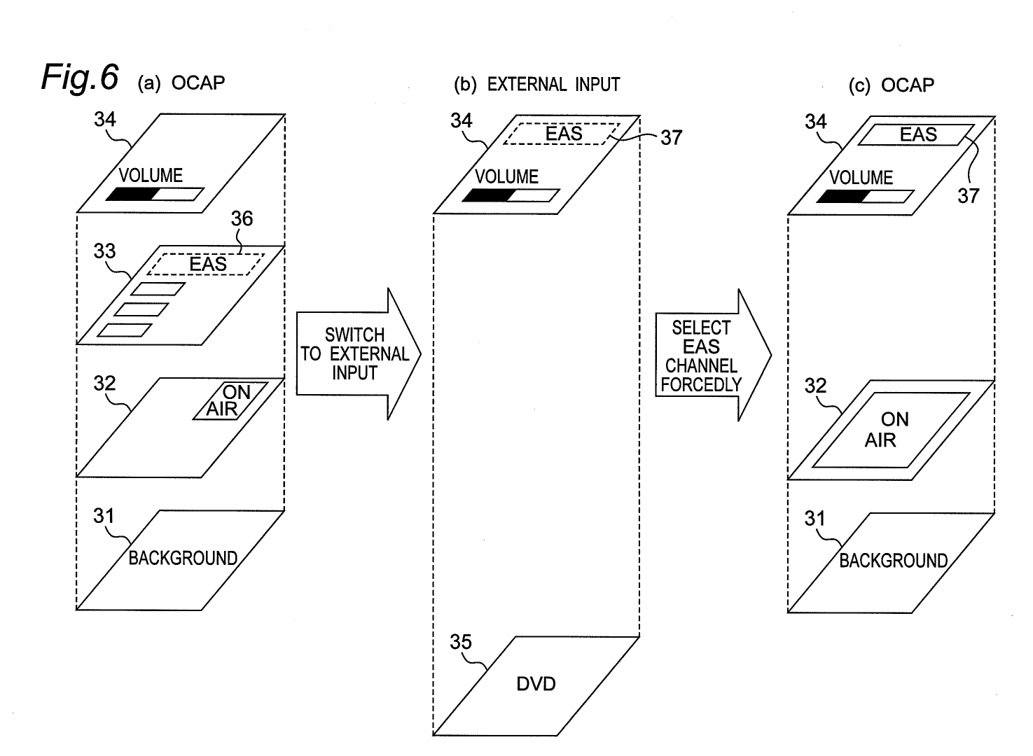

FIG. 6 shows transition of the hierarchies of the planes when the EAS forced channel selection is generated after the mode is switched from the OCAP mode to the external input mode. FIG. 6(a) shows the hierarchy of the plane synthesized under the OCAP mode, and FIG. 6(b) shows the hierarchy of the plane synthesized under the external input mode. FIGS. 6(a) and 6(b) show the same hierarchies as those in FIGS. 4A and 4B. According to the OCAP mode in FIG. 6(a), since the EAS 36 is displayed in the OSD plane 33, the display of the EAS in the receiver only plane 34 is set to “prohibition” (S502 in FIG. 5). When the mode is switched to the external input in this state, the hierarchy is transited to that in FIG. 6(b). Under the external input mode in FIG. 6(b), the display of the EAS 37 in the receiver only plane 34 is set to “permission” (S504 in FIG. 5). When the emergency alert broadcast is generated in this state, the channel is forcedly selected, and then the hierarchy is transited to that in FIG. 6(c).

FIG. 6(c) shows a hierarchy of the plane when the forced channel selection is generated and the mode is returned to the OCAP mode. Although the hierarchy is provided as shown in FIG. 6(a) in the normal OCAP mode, according to this embodiment, when the forced channel selection is generated, the OSD plane 33 is prevented from being displayed on the display 11 as shown in FIG. 6(c). Thus, the EAS only in the receiver only plane 34 is displayed on the display 11. In addition, when the forced channel selection is generated, the screen of the video plane 32 is returned to be full-size.

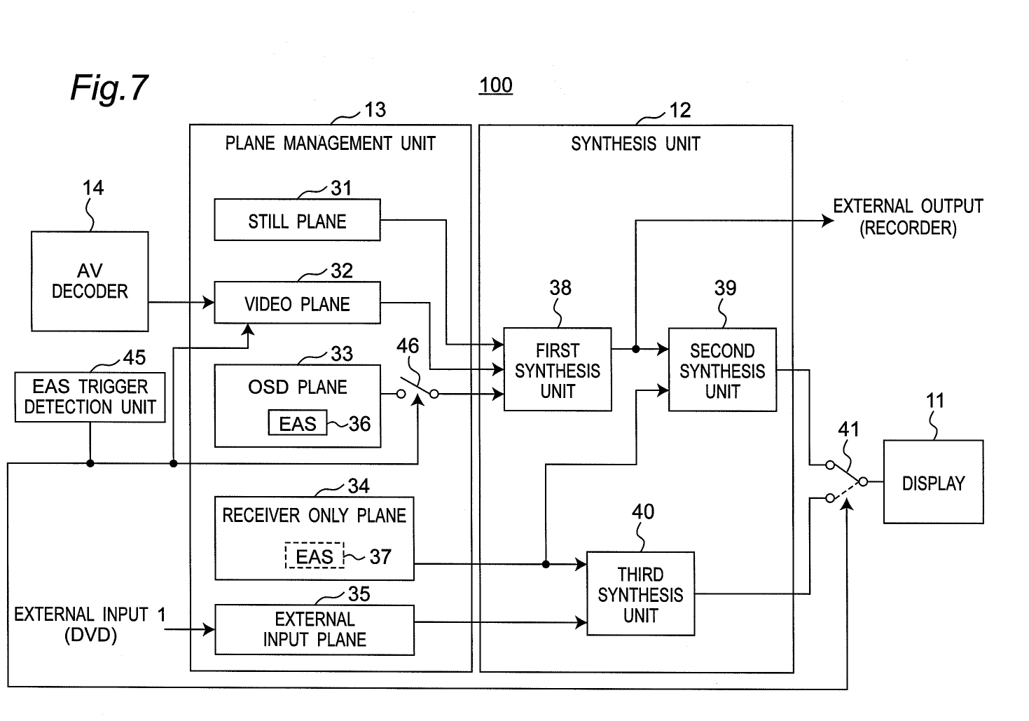

FIG. 7 shows a configuration of a receiver 100 to implement the plane hierarchy shown in FIG. 6(c). The receiver 100 further includes an EAS trigger detection unit 45 for detecting an EAS trigger sent to the receiver 100 at a predetermined interval when the emergency alert broadcast is generated, and a switch 46 for switching the OSD plane 33 so as not to be displayed when the EAS trigger is detected, in addition to the configuration in FIG. 3. When the EAS trigger detection unit 45 detects the EAS trigger, the switch 46 is turned off and the switch 41 is connected to the second synthesis unit 39.

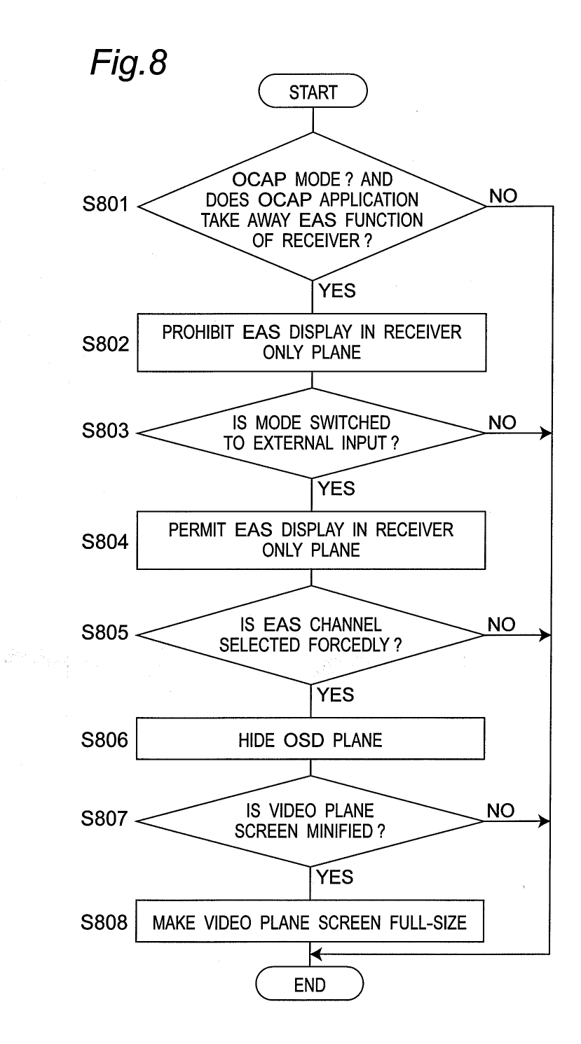

FIG. 8 shows control of the CPU 10 corresponding to the transition shown in FIGS. 6(a) to 6(c). In FIG. 8, since steps S801 to S804 corresponding to the transition from FIG. 6(a) to FIG. 6(b) are the same as S501 to S504 in FIG. 5, their description will be omitted. A description will be made from S805.

The CPU 10 determines whether the forced channel selection is generated or not based on whether the EAS trigger detection unit 45 detects the EAS trigger or not (S805). When the forced channel selection is generated, the switch 41 connected to the third synthesis unit 40 is switched so as to be connected to the second synthesis unit 39. In addition, the CPU 10 turns off the switch 46 so that the OSD plane 33 is prevented from being outputted to the first synthesis unit 38 (S806). Thus, the OSD plane 33 is not displayed on the display 11 and the Still plane 31 and the video plane 32 synthesized by the first synthesis unit 38 and the receiver only plane 34 synthesized by the second synthesis unit 39 are displayed. In addition, the CPU 10 determines whether the screen of the video plane 32 is minified or not (S807). When the screen of the video plane 32 is minified, it is returned to be full-size (S808).

Since the OSD plane 33 is controlled by the broadcast station, the receiver 100 cannot display/hide the EAS 36 in the OSD plane 33 independently from the control of the broadcast station. Thus, when the switch 46 is turned off and the OSD plane 33 itself is not synthesized, even after the forced channel selection is generated and the switch 41 is switched, the EAS 36 of the OSD plane 33 can be prevented from being displayed on the display 11. Thus, the EAS can be displayed only in the receiver only plane 34. In addition, the switch 46 is turned on when a predetermine time has elapsed after the EAS trigger was detected.

Note that although the OSD plane 33 itself is prevented from being displayed and the EAS is displayed only in the receiver only plane 34 to display the EAS in one plane in the above embodiment, it may be such that the EAS 36 is displayed in the OSD plane 33 and the EAS 37 of the receiver only plane 34 is not displayed. Since the receiver 100 can control the display/hide of the EAS 37 in the receiver only plane 34, it is not necessary to hide the receiver only plane 34 itself. In this case, the planes outputted on the display 11 are the receiver only plane 34, the OSD plane 33, the video plane 32 and the Still plane 31.

1.3.3 EAS Display Control when Mode is Switched from OCAP Mode to External Input Mode while EAS is Displayed

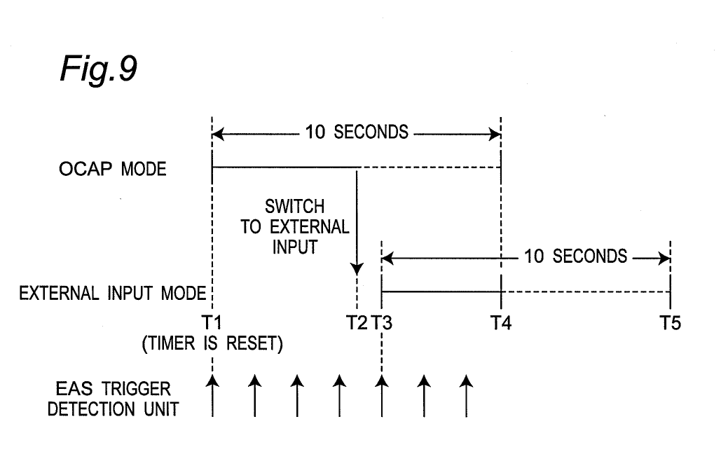

A description will be made of a case where the mode is switched from the OCAP mode to the external input mode and the EAS 37 is displayed in the receiver only plane 34. FIG. 9 shows a display period of the EAS. When the EAS trigger is detected under the OCAP mode (time T1), the EAS is displayed on the display 11 for a predetermined period of time (10 seconds, for example). While the EAS is displayed on the display 11, when the user switches the mode from the OCAP mode to the external input mode (time T2), the display of the EAS 37 in the receiver only plane 34 under the external input mode is started when the EAS trigger is detected after switching and continued for the predetermined period of time. Thus, the EAS is displayed on the display 11 for a total period of time including a period of time from when the EAS is started displaying under the OCAP mode till when the mode is switched to the external input mode (time T1 to time T2) and the predetermined period of time since the EAS trigger is detected after the mode is switched to the external input mode (time T3 to time T5), which is longer than the set predetermined period of time (time T1 to T4).

Thus, according to this embodiment, it is an object of the present invention to display the EAS only for the predetermined period of time in total (time T1 to time T4) even when the user switches from the OCAP mode to the external input mode while the EAS is displayed on the display 11 under the OCAP mode.

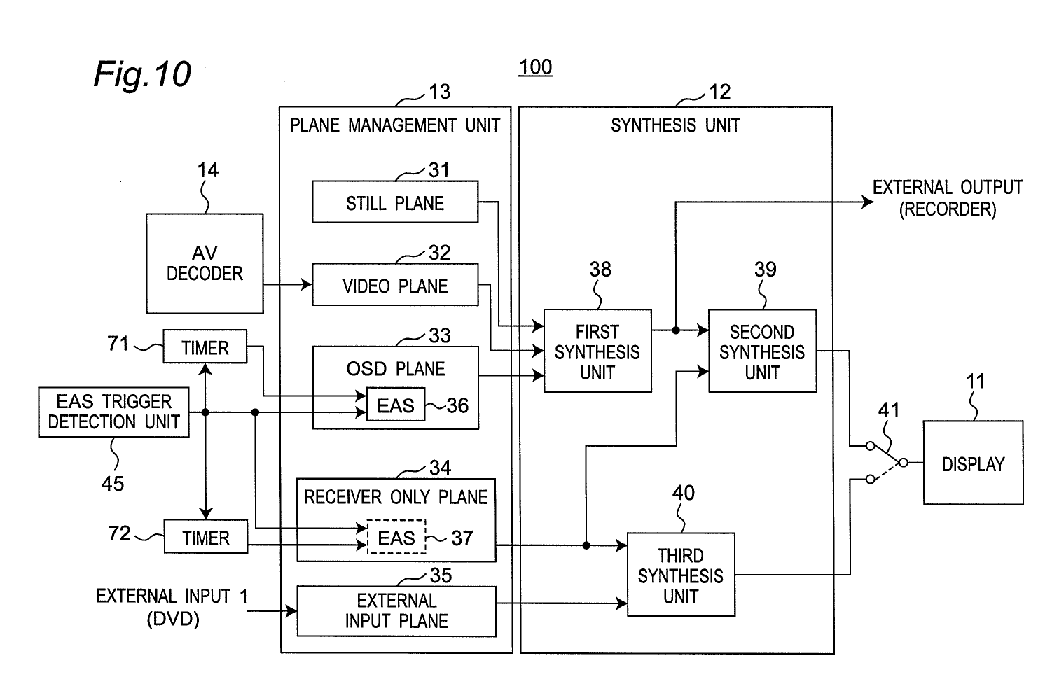

A configuration of a receiver 100 to attain the above object is shown in FIG. 10. The receiver 100 further includes timers 71 and 72. The timers 71 and 72 are set to a predetermined period of time (10 seconds in this embodiment). The timers 71 and 72 are used to set the display times of the EAS in the OSD plane 33 and the receiver only plane 34, respectively.

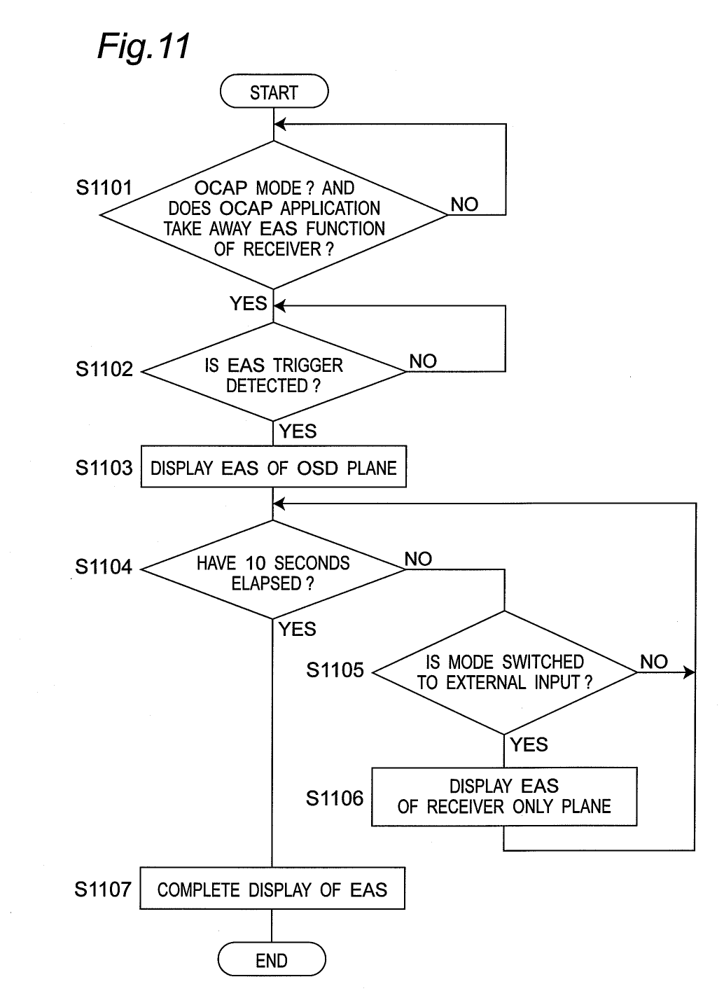

FIG. 11 shows a control flow of the CPU 10 to control the display time of the EAS 37 in the receiver only plane 34. The control shown in FIG. 11 is executed by the function shown in FIG. 2 which is realized when the CPU 10 executes a predetermined program. The operation mode management unit 55 of the CPU 10 determines whether or not, under the OCAP mode, the OCAP application has taken away the EAS function of the receiver 100 using the API compliant with the OCAP standard (S1101). In the case of YES in S1101, the CPU 10 determines whether the EAS trigger has been detected by the EAS trigger detection unit 45 or not (S1102). When the EAS trigger is detected, the EAS 36 is displayed in the OSD plane 33 (S1103). The CPU 10 determines whether 10 seconds set by the timer 71 has elapsed or not (S1104). After 10 seconds has elapsed, the display of the EAS is completed (S1107). When it is determined that 10 seconds has not yet elapsed, it is determined by the key delivery unit 56 whether the mode has been switched to the external input or not (S1105). When the mode is switched to the external input before 10 seconds elapses (YES in S1105), the EAS 37 is displayed in the receiver only plane 34 (S1106). Thereafter, it is determined whether 10 seconds set by the timer 72 has elapsed or not (S1104), and the EAS 37 is displayed in the receiver only plane 34 until 10 seconds has elapsed. After 10 seconds has elapsed, the display of the EAS is completed (S1107).

Thus, since the timers 71 and 72 are provided, even when the mode is switched from the OCAP mode to the external input mode while the EAS is displayed, the display of the EAS is controlled so as to be completed in the predetermined period of time after the start of the display of the EAS.

Note that although the timers 71 and 72 are provided in this embodiment, one timer may be shared.

### Second Embodiment

In this embodiment, a configuration in which a plane managed by the plane management unit 13 is newly added will be described. In this embodiment, the main configuration of the receiver 100 is the same as those shown in FIGS. 1 and 2.

### 2.1 EAS Only Plane

According to the first embodiment, after the OCAP application deprives the embedded application of the EAS function using the API compliant with the OCAP standard, in the case where the emergency alert broadcast is generated, as shown in FIG. 4C, the OSD plane 33 in which the EAS 36 is displayed is outputted from the external output to the recorder. Thus, the problem is that when the recorded video is reproduced, the EAS 36 is displayed on the screen. Furthermore, since there is a difference in font and size of the characters between the display of the EAS 36 in the OSD plane 33 and the display of the EAS 37 in the receiver only plane 34, when the mode is switched from the OCAP mode to the external input mode, the difference appears on the display 11 (from FIG. 4A to FIG. 4B). Such a problem is to be solved in this embodiment.

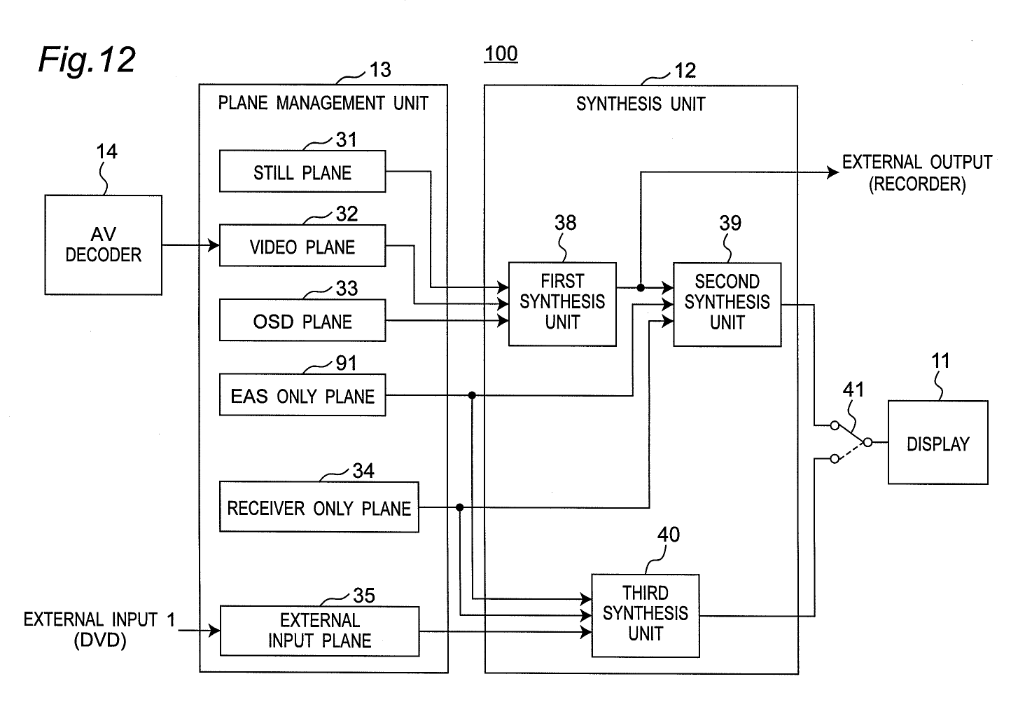

FIG. 12 shows a configuration of a plane management unit 13 according to this embodiment. The plane management unit 13 according to this embodiment has an EAS only plane 91 for displaying the EAS. According to this embodiment, when the OCAP application deprives the embedded application of the EAS function using the API compliant with the OCAP standard, the EAS is displayed using the EAS only plane 91. Thus, the EAS of the OSD plane 33 is not displayed. The EAS only plane 91 is outputted to a second synthesis unit 39 and a third synthesis unit 40. Other configuration of the plane management unit 13 is the same as that shown in FIG. 3.

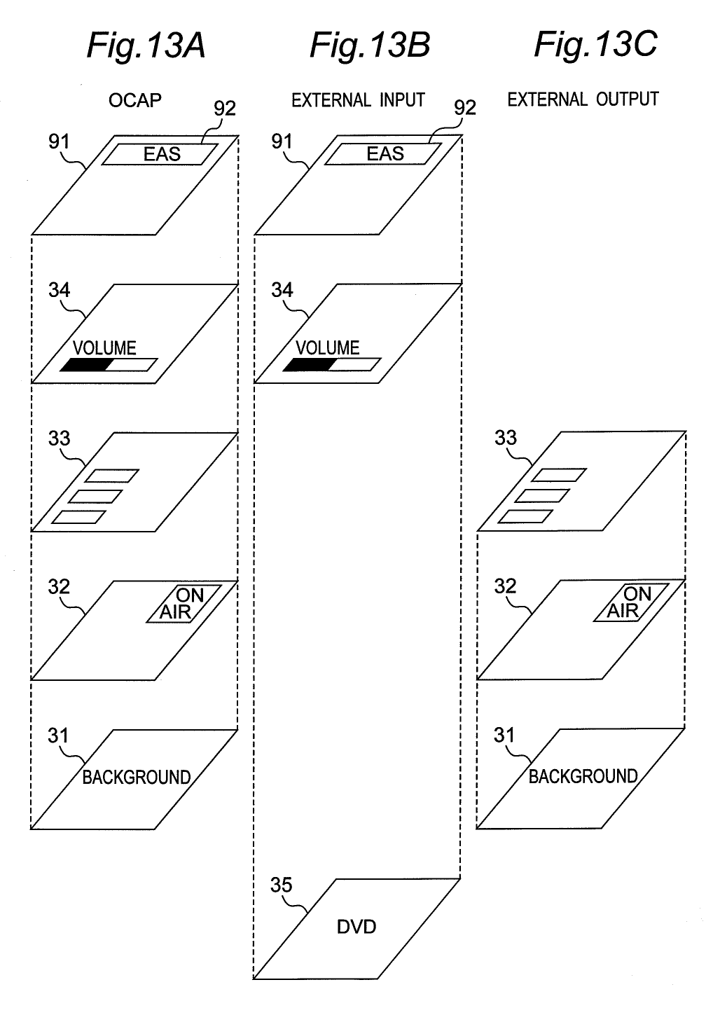

FIGS. 13A to 13C show hierarchies of the planes in this embodiment. FIG. 13A shows a hierarchy under the OCAP mode. Under the OCAP mode, the EAS only plane 91 is arranged on a receiver only plane 34. FIG. 13B shows a hierarchy under the external input mode, in which the EAS only plane 91 is arranged on the receiver only plane 34. FIG. 13C shows a hierarchy under the external output mode. Since screen data to be outputted to the outside is an output of a first synthesis unit 38, the EAS only plane 91 that is not synthesized by the first synthesis unit 38 is not displayed.

Thus, according to the second embodiment, since the EAS only plane 91 is provided, the plane in which the EAS is not displayed can be outputted to the outside. Therefore, when the video recorded once in the recorder is reproduced, an EAS 92 is not displayed (FIG. 13C).

Note that, according to the second embodiment, when the OCAP application deprives the embedded application of the EAS function using the OCAP-compliant API, the EAS 92 is displayed using the EAS only plane 91, in both the OCAP mode and the external input mode. Thus, the problem that the font and the size of the characters are different due to the difference in the mode can be solved (FIG. 13A and FIG. 13B).

In addition, according to this embodiment, when the EAS is displayed by the embedded application, the EAS is displayed using the receiver only plane 34. However, when the EAS is displayed by the embedded application, the EAS only plane 91 may be used.

### 2.2 PIN Only Plane

Conventionally, a personal identification number input screen (referred to as the “PIN screen”) to cancel parental control under the OCAP mode is implemented by using the OSD plane 33. However, the problem is that since the OSD plane 33 is outputted to the outside as shown in FIG. 13C, when a mode is switched to the external input mode and screen data recorded by an external device is reproduced, the PIN screen in the OSD plane 33 is displayed and the image of the video plane 32 arranged under the PIN screen cannot be seen.

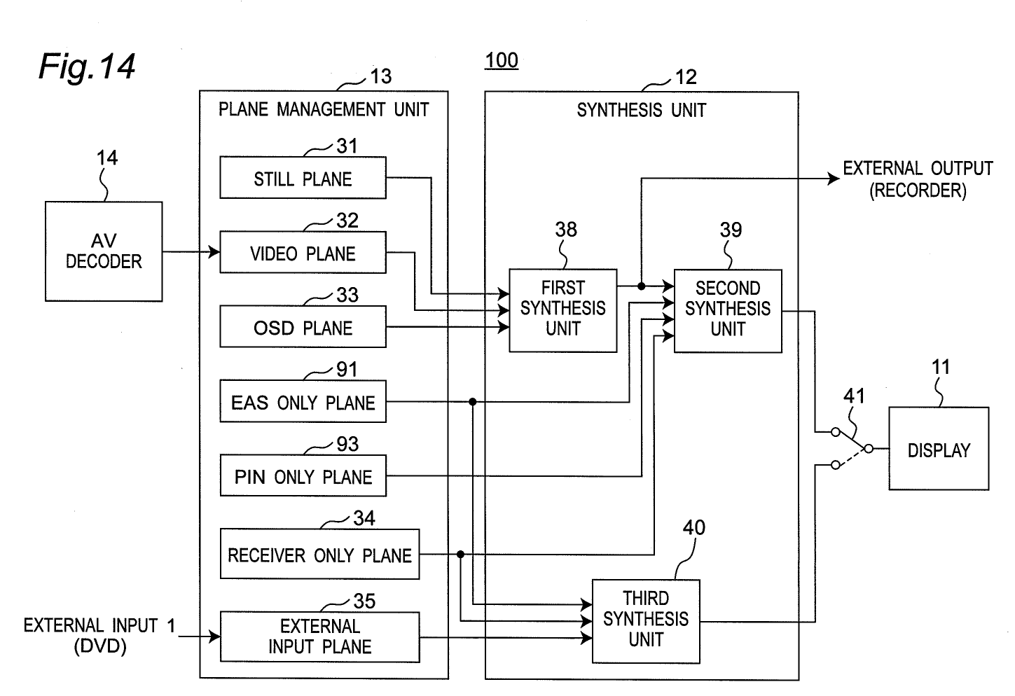

A configuration of a plane management unit 13 to solve the above problem is shown in FIG. 14. The plane management unit 13 further has a PIN only plane 93 to display the personal identification number input screen. The PIN only plane 93 is outputted only to the second synthesis unit 39. Other configuration in FIG. 14 is the same as that in FIG. 12.

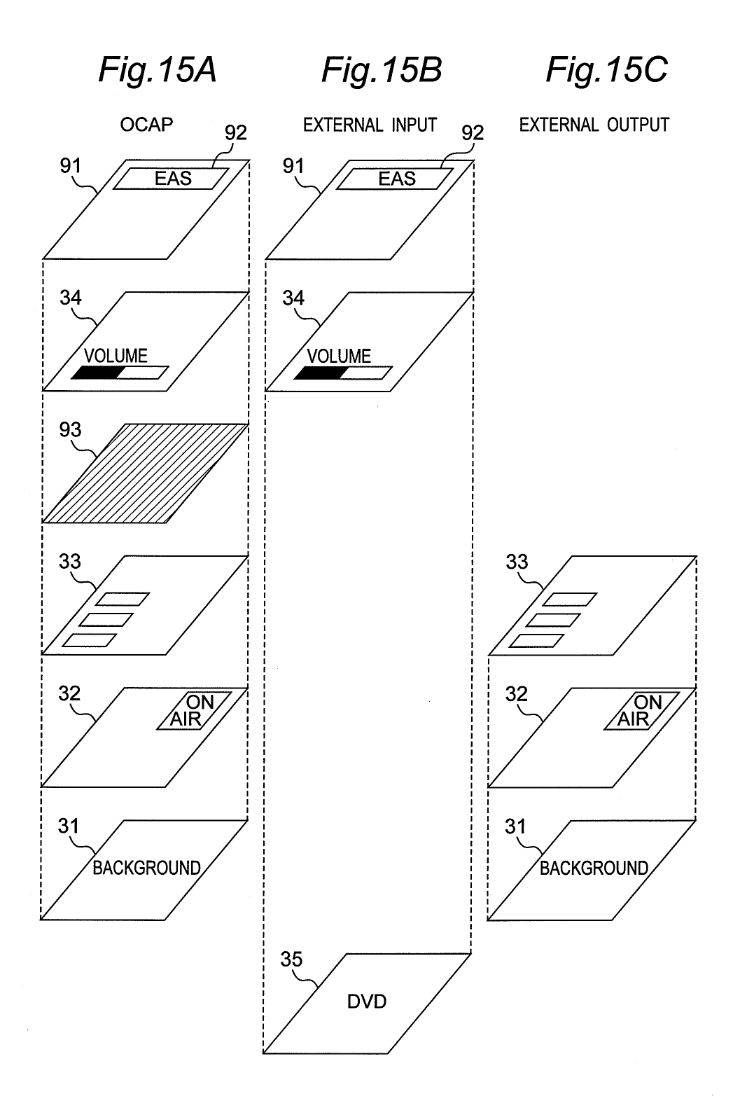

FIGS. 15A to 15C show hierarchies of planes including the PIN only plane. FIG. 15A shows a hierarchy under the OCAP mode. Under the OCAP mode, the PIN only plane 93 is arranged between the receiver only plane 34 and the OSD plane 33. FIG. 15B shows a hierarchy under the external input mode. Since the PIN only plane 93 is not inputted to the third synthesis unit 40, the PIN only plane 93 is not displayed. FIG. 15C shows a hierarchy under the external output mode. Since the PIN only plane 93 is not inputted to the first synthesis unit 38, the PIN only plane 93 is not displayed.

Thus, since the PIN only plane 93 is provided and the PIN only plane 93 is outputted only to the second synthesis unit 39, the PIN screen is prevented from being outputted under the external output mode (FIG. 15C). Therefore, when the screen data recorded in the external output mode is reproduced in the external input mode, the PIN screen is not displayed and the user can see the video of the video plane 32.

Note that although the EAS only plane 91 as well as the PIN only plane 93 are provided in FIGS. 14 and 15, the PIN only plane 93 may be used in the configuration of the first embodiment in which the EAS only plane 91 is not provided.

According to the present invention, since various kinds of problems regarding the display due to the switching of the mode can be solved, it is effectively applied to a digital broadcast receiver for receiving the OCAP-compliant cable broadcast. For example, even when the display is switched from the OCAP application to the external device, since the emergency alert broadcast by the EAS can be displayed, the present invention can be useful for a digital broadcast receiver capable of displaying the EAS.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present disclosure relates to subject matter contained in Japanese Patent Application No. 2007-204404, filed on Aug. 6, 2007, which is expressly incorporated herein by reference in its entirety.

What is claimed is:

1. A digital broadcast receiver which implements functions by an embedded application and a download application acquired through a network, the embedded application having a function of displaying an emergency alert broadcast, and the download application being capable of taking away the function of displaying the emergency alert broadcast, said digital broadcast receiver comprising:
a plane management unit that manages a download application plane capable of displaying the emergency alert broadcast by the download application, a receiver only plane capable of displaying the emergency alert broadcast by the embedded application, and an external input plane capable of displaying information inputted from an external device;
a synthesis unit that generates first screen data by synthesizing the download application plane and the receiver only plane, and generates second screen data by synthesizing the external input plane and the receiver only plane;
a display that displays the first screen data under a first mode in which the download application is executed, and displays the second screen data under a second mode in which information inputted from the external device is displayed; and
a control unit that controls whether or not to display the emergency alert broadcast in the receiver only plane, and prohibits the emergency alert broadcast from being displayed in the receiver only plane when, under the first mode, the download application takes away the function of displaying the emergency alert broadcast;
wherein the control unit permits the emergency alert broadcast to be displayed in the receiver only plane when a mode is switched from the first mode to the second mode.

2. The digital broadcast receiver according to claim 1, wherein
the emergency alert broadcast is a broadcast to deliver character information and to control displaying of video information by controlling displaying of the first screen data on the display and a forced channel selection,
the download application plane includes an OSD plane for displaying the character information, and a video plane for displaying the video information, and
the control unit prevents the OSD plane from being outputted from the plane management unit to the synthesis unit when the emergency alert broadcast is delivered and the first screen data is forcedly displayed on the display after the mode is switched from the first mode to the second mode under the condition that the download application takes away the function of displaying the emergency alert broadcast.

3. The digital broadcast receiver according to claim 1, wherein
the emergency alert broadcast is a broadcast to deliver character information and to control displaying of video information by controlling displaying of the first screen data on the display and a forced channel selection, and
the control unit prohibits the emergency alert broadcast from being displayed in the receiver only plane when the emergency alert broadcast is delivered and the first screen data is forcedly displayed on the display after the mode is switched from the first mode to the second mode under the condition that the download application takes away the function of displaying the emergency alert broadcast.

4. The digital broadcast receiver according to claim 1, further comprising:
a timer that sets a time period during which the emergency alert broadcast is displayed;
wherein, the control unit completes the display of the emergency alert broadcast under the second mode when a time since start of the display of the emergency alert broadcast under the first mode reaches the time set in the timer, in the case where the mode is switched from the first mode to the second mode before a time since the start of the display of the emergency alert broadcast under the first mode reaches the time set in the timer under the condition that the download application takes away the function of displaying the emergency alert broadcast.

5. A digital broadcast receiver which has a first mode in which screen data displayed by executing a download application acquired through a network is outputted to the outside, a second mode in which the download application is executed to display screen data, and a third mode in which information inputted from an external device is displayed, said digital broadcast receiver comprising:
a plane management unit that manages an emergency alert broadcast plane for displaying an emergency alert broadcast, a download application plane used when the download application is executed, a receiver only plane, and an external input plane for displaying information inputted from an external device;
a synthesis unit that generates first screen data by synthesizing the emergency alert broadcast plane and the download application plane, generates second screen data by synthesizing the first screen data and the receiver only plane, and generates third screen data by synthesizing the emergency alert broadcast plane, the external input plane and the receiver only plane; and
a display;
wherein the first screen data is outputted to the outside under the first mode, the second screen data is outputted to the display under the second mode, and the third screen data is outputted to the display under the third mode.

6. A digital broadcast receiver which has a first mode in which screen data displayed by executing a download application acquired through a network is outputted to the outside, a second mode in which the download application is executed to display screen data, and a third mode in which information inputted from an external device is displayed, said digital broadcast receiver comprising:
a plane management unit that manages a personal identification number plane for displaying a personal identification number input screen, a download application plane used when the download application is executed, a receiver only plane, and an external input plane for displaying information inputted from an external device;
a synthesis unit that generates first screen data by synthesizing the personal identification number plane, the download application plane, and the receiver only plane, and generates second screen data by synthesizing the external input plane and the receiver only plane; and
a display;
wherein the download application plane is outputted to the outside under the first mode, the first screen data is outputted to the display under the second mode, and the second screen data is outputted to the display under the third mode.
